(19) United States
(12) Patent Application Publication
(10) Pub. No.: US 2025/0029263 A1
(43) Pub. Date: Jan. 23, 2025

(54) REGION ESTIMATION SYSTEM, REGION ESTIMATION PROGRAM, AND REGION ESTIMATION METHOD

(71) Applicant: Konica Minolta, Inc., Tokyo (JP)

(72) Inventor: Kazuma KAWAKAMI, Tokyo (JP)

(21) Appl. No.: 18/713,914

(22) PCT Filed: Nov. 4, 2022
(86) PCT No.: PCT/JP2022/041182

§ 371 Date: May 28, 2024

(30) Foreign Application Priority Data
Dec. 3, 2021 (JP) 2021-196700

(51) Int. Cl. G06T 7/215; G06T 7/77; G06T 7/90; G06V 20/52

(52) U.S. Cl. CPC G06T 7/215; G06T 7/77; G06T 7/90; G06V 20/52; G06T 2207/20081; G06T 2207/30196

(57) ABSTRACT

A region estimation system is provided which can complement a joint or a region while eliminating a need for a worker to wear a terminal and a need to perform new learning is not required even in a case where the joint or the region desired to be estimated is not estimated for some reason. A region estimation system includes: a detector that detects a joint point of an object from an image of the object; and an estimator that estimates a region to be estimated, based on the joint point detected by the detector.

### TECHNICAL FIELD

The present invention relates to a region estimation system, a region estimation program, and a region estimation method.

### BACKGROUND ART

In recent years, in order to prevent an accident of a worker or the like in a manufacturing site such as a factory, a technology has been developed, which detects a behavior of the worker based on an image captured by a camera, thereby enabling an appropriate response based on the detected behavior.

In connection with the above technique, the following Patent Literature 1 discloses the following technique. A human skeleton is estimated by machine learning based on image information acquired by a camera or the like fixedly installed in a facility. Next, when a worker is hidden in a blind spot of the camera, the estimated skeleton is corrected using sensor information acquired from a worker terminal, such as a first-person viewpoint camera or an acceleration sensor worn by the worker. Thus, even in a case where a part of an image of a person is not acquired, it is possible to grasp a detailed motion of the person and to appropriately support the motion of the worker.

### CITATION LIST

### Patent Literature

Patent Literature 1: JP 2021-56922

### SUMMARY OF INVENTION

### Technical Problem

However, in the technique disclosed in Patent Literature 1, since it is necessary for the worker to wear the terminal, there is a problem in that the cost is increased and the work efficiency is reduced due to the wearing of the terminal. Furthermore, in a case where a joint or a region to be estimated is added, there is a problem in that it is necessary to newly perform learning.

The present invention has been devised in order to solve those problems. That is, an object of the present invention is to provide a region estimation system, a region estimation program, and a region estimation method that can complement a joint or a region that is desired to be estimated while eliminating a need for a worker to wear a terminal and a need to perform new learning even in a case where the joint or the region is not estimated for some reason.

### Solution to Problem

The above problems that the present invention addresses are solved by the following means.

(1) A region estimation system including: a detector that detects a joint point of an object from an image of the object; and an estimator that estimates a region to be estimated, based on the joint point detected by the detector.

(2) The region estimation system according to (1), in which the estimator estimates, based on the joint point detected in a frame of the image, the region to be estimated in the frame in which the joint point has been detected.

(3) The region estimation system according to (1) or (2), further including a determinator that determines whether or not the region to be estimated is present, based on the detected joint point, in which the estimator estimates the region to be estimated in a case where the determinator determines that the region to be estimated is not present, the region estimation system further including: a corrector that corrects the joint point by complementing the detected joint point in the estimated region; and a color information acquirer that acquires color information belonging to the object from the image based on the estimated region.

(4) The region estimation system according to (1) or (2), further including: a corrector that corrects the joint point by complementing the detected joint point in the estimated region: a reception section that receives designation of a color information acquisition region; and a color information acquirer that acquires color information belonging to the object from the image based on the received designation of the color information acquisition region.

(5) The region estimation system according to (4), further including a switching section that switches a size of the region to be estimated according to the region to be estimated.

(6) The region estimation system according to any one of (1) to (5), in which the region to be estimated is the joint point or a region including the joint point.

(7) The region estimation system according to any one of (1) to (6), further including an image acquirer that acquires the image.

(8) The region estimation system according to any one of (1) to (7), in which the object includes a person.

(9) The region estimation system according to any one of (1) to (8), in which the object has a joint.

(10) The region estimation system according to any one of (1) to (9), in which the region to be estimated is a region including the joint point of a head.

(11) The region estimation system according to any one of (3) to (5), further including: a behavior estimator that estimates a behavior of the object based on the corrected joint point: an identification information determinator that determines identification information individually identifying the object based on the color information acquired by the color information acquirer; and an output section that outputs, for each object, the behavior estimated by the behavior estimator and the identification information determined by the identification information determinator in association with each other.

(12) A region estimation program for causing a computer to execute a process, the process including: (a) detecting a joint point of an object from an image of the object; and (b) estimating a region to be estimated, based on the joint point detected in (a).

(13) The region estimation program according to (12), in which in (b), the region to be estimated in a frame in which the joint point has been detected is estimated based on the joint point detected in the frame of the image.

(14) The region estimation program according to (12) or (13), the process further including: (c) determining whether or not the region to be estimated is present, based on the detected joint point, in which the region to be estimated is estimated in a case where it is determined that the region to be estimated is not present in (b), the process further including: (d) correcting the joint point by complementing the detected joint point in the estimated region; and (e) acquiring color information belonging to the object from the image based on the estimated region.

(15) A region estimation method including: (a) detecting a joint point of an object from an image of the object; and (b) estimating a region to be estimated, based on the joint point detected in (a).

(16) The region estimation method according to (15), in which in (b), the region to be estimated in a frame in which the joint point has been detected is estimated based on the joint point detected in the frame of the image.

(17) The region estimation method according to (15) or (16), further including: (c) determining whether or not the region to be estimated is present, based on the detected joint point, in which the region to be estimated is estimated in a case where it is determined that the region to be estimated is not present in (b), the region estimation method further including: (d) correcting the joint point by complementing the detected joint point in the estimated region; and (e) acquiring color information belonging to the object from the image based on the estimated region.

### Advantageous Effects of Invention

A position of a joint of an object is detected from an image of the object, and a region to be estimated is estimated based on the position of the joint. Accordingly, even in a case where a joint or a region desired to be estimated is not estimated for some reason, it is possible to complement the joint or the region while eliminating a need for a worker to wear a terminal and a need to perform new learning.

### BRIEF DESCRIPTION OF DRAWINGS

FIG. 1 is a diagram illustrating a schematic configuration of an analysis system.

FIG. 2 is a block diagram illustrating a hardware configuration of an analysis apparatus.

FIG. 3 is a block diagram illustrating functions of a controller of the analysis apparatus.

FIG. 4 is an explanatory view illustrating a method of estimating a region to be estimated.

FIG. 5 is a flowchart illustrating an operation of the analysis apparatus.

FIG. 6 is a block diagram illustrating functions of a controller of an analysis apparatus.

### DESCRIPTION OF EMBODIMENTS

A region estimation system, a region estimation program, and a region estimation method according to an embodiment of the present invention will be described below with reference to the drawings. In the drawings, the same components are denoted by the same reference signs, and redundant description is omitted. In addition, dimensional ratios in the drawings are exaggerated for convenience of description and may be different from actual ratios.

### First Embodiment

FIG. 1 is a diagram illustrating a schematic configuration of an analysis system 10. The analysis system 10 forms a region estimation system.

The analysis system 10 includes an analysis apparatus 100, an image capturing apparatus 200, and a communication network 300. The analysis apparatus 100 is communicably connected to the image capturing apparatus 200 via the communication network 300. The analysis system 10 may be constituted by the analysis apparatus 100 alone. The image capturing apparatus 200 forms an image acquirer.

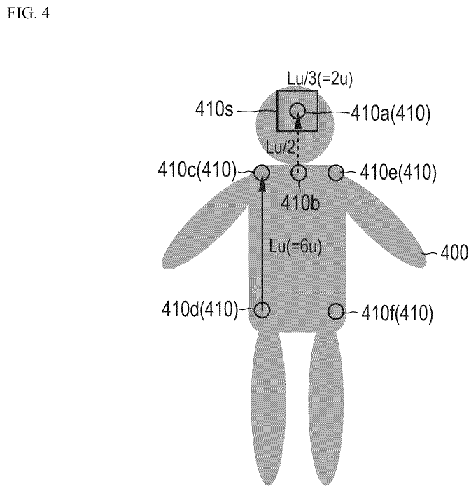

The analysis apparatus 100 detects a joint point 410 (see FIG. 4) of an object included in a captured image received from the image capturing apparatus 200, estimates, based on the joint point 410, a region to be estimated (described later), and corrects the joint point 410 by complementing the joint point 410 in the estimated region. The analysis apparatus 100 estimates a behavior of the object based on the corrected joint point 410, and determines identification information individually identifying the object, based on acquired color information of the region to be estimated. The object may be an object having a joint, such as a person. Hereinafter, in order to simplify the description, the object will be described as a target person 400 (see FIG. 4) who is a person.

The image capturing apparatus 200 is constituted by, for example, a near-infrared camera, is installed at a predetermined position, and captures an image of an imaging region from the predetermined position. The image capturing apparatus 200 can capture an image of an imaging region by irradiating the imaging region with near infrared light by a light emitting device (LED) and receiving, by a complementary metal oxide semiconductor (CMOS) sensor, the near infrared light reflected off the object present in the imaging region. The captured image may be a monochrome image in which each pixel represents the reflectance of the near-infrared light. The predetermined position may be, for example, a ceiling of a manufacturing factory where the target person 400 works as a worker. The imaging region may be, for example, a three-dimensional region including the entire floor of the manufacturing factory. The image capturing apparatus 200 can capture an image of the imaging region as a moving image including a plurality of captured images (frames) at a frame rate ranging from 15 fps to 30 fps, for example.

For the communication network 300, a network interface compliant with a wired communication standard such as Ethernet (registered trademark) may be used. For the communication network 300, a network interface compliant with wireless communication standards such as Bluetooth (registered trademark) and IEEE802.11 may be used.

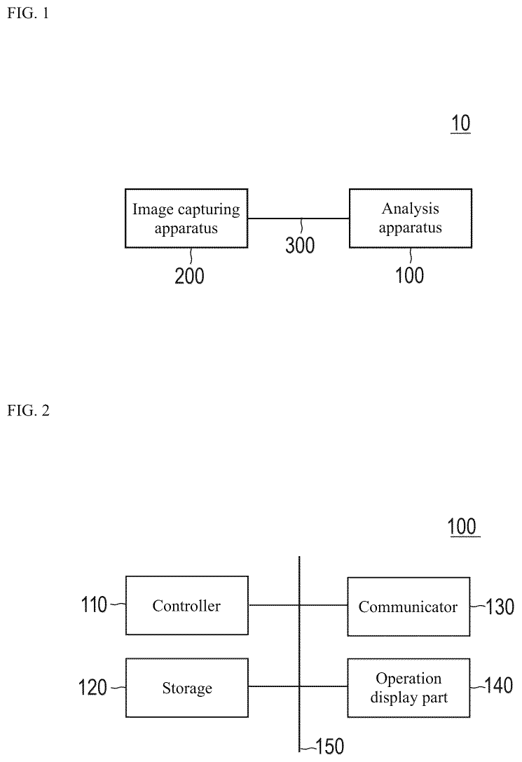

FIG. 2 is a block diagram illustrating a hardware configuration of the analysis apparatus 100. The analysis apparatus 100 includes a controller 110, a storage 120, a communicator 130, and an operation display part 140. Those constituent elements are connected to each other via a bus 150. The analysis apparatus 100 may be constituted by a computer.

The controller 110 includes a central processing unit (CPU), and controls various components of the analysis apparatus 100 and performs arithmetic processing in accordance with a program. Details of functions of the controller 110 will be described later.

The storage 120 may include a random access memory (RAM), a read only memory (ROM), and a flash memory: The RAM, as a workspace of the controller 110, temporarily stores therein a program and data. The ROM stores therein various kinds of programs or various pieces of data in advance. The flash memory stores therein various kinds of programs including an operation system and various pieces of data.

The communicator 130 is an interface for communicating with an external device. For communication, a network interface compliant with a standard such as Ethernet (registered trademark), SATA, PCI Express, USB, or IEEE1394 may be used. In addition, a wireless communication interface compliant with Bluetooth (registered trademark), IEEE 802.11, and 4G is used for communication. The communicator 130 receives a captured image from the image capturing apparatus 200.

The operation display part 140 includes, for example, a liquid crystal display, a touch screen, and various keys. The operation display part 140 receives various kinds of operation and input and displays various kinds of information.

Functions of the controller 110 will be described.

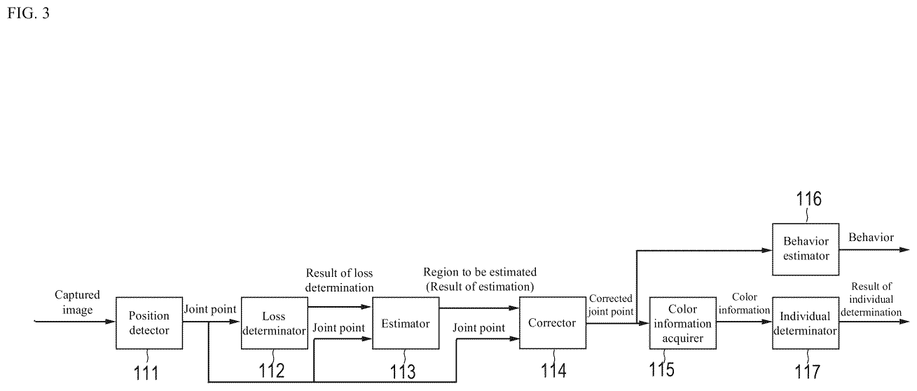

FIG. 3 is a block diagram illustrating the functions of the controller 110 of the analysis apparatus 100. The controller 110 functions as a position detector 111, a loss determinator 112, an estimator 113, a corrector 114, a color information acquirer 115, a behavior estimator 116, and an individual determinator 117 by executing a program. The position detector 111 forms a detector. The loss determinator 112 forms a determinator. The individual determinator 117 forms an identification information determinator. The behavior estimator 116 and the individual determinator 117 form an output section.

The position detector 111 detects the joint point 410 of the target person 400 from a captured image of the object. Specifically, the position detector 111 detects the joint point 410 as, for example, coordinates of a pixel in the captured image. In a case where a plurality of target persons 400 are included in the captured image, the position detector 111 detects a joint point 410 for each of the target persons 400. In the following description, for the sake of simplicity, it is assumed that the number of target persons 400 included in the captured image is one.

The position detector 111 detects the joint point 410 by estimating the joint point 410 from the captured image using machine learning. The position detector 111 can detect the joint point 410 by using known deep learning, for example, Deep Pose, a convolution neural network (CNN), and Res Net. The position detector 111 may detect the joint point 410 by using machine learning other than deep learning, such as a support vector machine (SVM) and a random forest. For example, the joint point 410 may include the head, nose, neck, shoulders, elbows, wrists, hips, knees, ankles, eyes, and ears. A case where joint points 410 detected by the position detector 111 are five joint points 410 of the neck, the shoulders (the right shoulder and the left shoulder), and the hips (the right hip and the left hip) will be described as an example.

The position detector 111 can calculate a likelihood for each of classes (classifications of the joint points 410, such as the left shoulder, the right shoulder, and the left hip) of the joint points 410 of the target person 400 for each pixel of the captured image and detect a pixel having a likelihood equal to or higher than a predetermined threshold as a joint point 410. Thus, a pixel having a likelihood lower than the predetermined threshold is not detected as a joint point 410. Therefore, there is a possibility that a joint point 410 among the joint points 410 is not detected due to the degree of clarity of an image of the target person 400 in the captured image, the effect of occlusion, or the like.

The loss determinator 112 determines whether or not a loss of the joint points 410 or the like due to a joint point 410 that is among the joint points 410 and is not detected (estimated) for some reason is present, based on the joint points 410 of the target person 400 detected by the position detector 111. Specifically, the loss determinator 112 determines whether or not an undetected joint point 410 and/or a region (hereinafter, referred to as a “region to be estimated”) that includes the joint points 410 and that needs to be estimated is present. The presence of the region to be estimated corresponds to the presence of a loss of the joint points 410 or the like. The absence of the region to be estimated corresponds to the absence of a loss of the joint points 410 or the like. The region including the joint points 410 is, for example, a region within a square of a predetermined size centered on the joint points 410. The region to be estimated may be set in advance.

Reasons why a joint point 410 is not detected include that the target person 400 is outside the imaging range of the image capturing apparatus 200 and that the joint point 410 is originally not a target to be detected by the position detector 111. That is, the region to be estimated includes (1) a region that cannot be acquired (detected) due to the installation position of the image capturing apparatus 200 or the like and (2) a region (a region that is not set to be detected by the position detector 111) that is not originally intended to be detected (acquired) by the position detector 111.

The loss determinator 112 determines whether or not the region to be estimated is present, for example, by comparing the classes (classifications of the joint points such as the left shoulder, the right shoulder, and the left hip) of the joint points 410 of the target person 400 detected by the position detector 111 with necessary joint points 410 (hereinafter simply referred to as a “necessary joint points”). The necessary joint points include (a) a joint point 410 which is set to be detected by the position detector 111 and (b) a joint point 410 which is not set to be detected by the position detector 111 but is necessary for acquiring color information which will be described later. Specifically, in a case where the joint point 410 of the “left shoulder” is included in the joint points 410 set to be detected by the position detector 111, but the joint point 410 of the “left shoulder” is not included in the joint points 410 detected by the position detector 111, the joint point 410 of the “left shoulder” corresponds to the above-described (1) region to be estimated, and thus the loss determinator 112 determines that the region to be estimated is present. Furthermore, in a case where the necessary joint points include a joint point 410 that corresponds to the above-described (b) and is not set to be detected by the position detector 111 but is necessary for acquiring the color information, the joint point 410 necessary for acquiring the color information or a region (hereinafter also referred to as an “identification region”) that is necessary for acquiring the color information and includes the joint point 410 is determined to be the region to be estimated. This is because the identification region corresponds to the above-described (2) region to be estimated. Therefore, in a case where the identification region is present, the loss determinator 112 determines that the region to be estimated is present. The identification region includes a joint point 410a (refer to FIG. 4) of the “head” or a head region 410s including the joint point 410a of the “head”.

The estimator 113 estimates the region to be estimated, based on the joint point 410) detected by the position detector 111. More specifically, the estimator 113 estimates the region to be estimated, based on the joint point 410 detected by the position detector 111 and a result of the loss determination by the loss determinator 112. Specifically, in a case where it is determined that the region to be estimated is not present in the result of the loss determination, the estimator 113 estimates the region to be estimated. The result of the loss determination by the loss determinator 112 may include information indicating whether or not the region to be estimated is present and information identifying the region that is to be estimated and has been determined not to be present. The determination of whether or not the region to be estimated is present may be omitted in a case where information identifying the region that is to be estimated and has been determined not to be present is present in the result of the loss determination. This is because, in a case where the result of the loss determination includes the information identifying the region that is to be estimated and has been determined not to be present, it can be determined that the region to be estimated has been determined to be present.

FIG. 4 is an explanatory diagram illustrating a method of estimating the region to be estimated. FIG. 4 illustrates, as a gray shape, an image of the target person 400 in the captured image to simplify the description.

In the example illustrated in FIG. 4, the head region 410s, which is the identification region, is set as the region to be estimated. However, the region to be estimated may be other than the head region 410s. That is, the region to be estimated may be any joint point 410 and a region including any joint point 410. Hereinafter, in order to simplify the description, unless otherwise particularly specified, the description will be given on the assumption that the region to be estimated is the head region 410s that is the identification region and includes the joint point 410a of the “head”.

The joint point 410a of the “head” can be estimated by calculation from, for example, a joint point 410c of the “right shoulder”, a joint point 410d of the “right hip”, and a joint point 410b of the “neck”. Specifically, a vector (Lu) having the joint point 410d of the “right hip” as a start point and the joint point 410c of the “right shoulder” as an end point is calculated. A vector (Lu/2) having a size of ½ of the size of the vector (Lu) and having the joint point 410b of the “neck” as a start point is calculated. Thus, the joint point 410a of the “head” is calculated as the end point of the vector (Lu/2). Next, the head region 410s that is a square range whose center is the joint point 410a of the “head” and whose one side has a length that is ⅓ of the size of the vector (Lu) can be calculated (estimated) as the region to be estimated. That is, in a case where ⅙ of the size of the vector (Lu) (vector of the upper body) is u and the coordinates of the joint point 410a of the “head” are (x, y), the region to be estimated can be calculated (estimated) as a square range having upper left coordinates of (x−u, y−u) and lower right coordinates of (x+u, y+u).

The region to be estimated may be estimated by machine learning based on the joint point 410c of the “right shoulder”, the joint point 410d of the “right hip”, and the joint point 410b of the “neck”. The region to be estimated may be estimated based on the joint points 410 other than the joint point 410c of the “right shoulder”, the joint point 410d of the “right hip”, and the joint point 410b of the “neck”.

The estimator 113 can switch the size of the region to be estimated according to the region to be estimated. As will be described later, the color information of the region to be estimated is acquired by the color information acquirer 115, and the target person 400 as an individual is determined by the individual determinator 117 based on the color information. This is because, in a case where the target person 400 wears a hat or the like having a color that can identify the individual, the target person 400 as an individual can be identified by acquiring the color information of the head region 410s that is the region to be estimated. Therefore, by switching the size of the region to be estimated according to the size or range of a specific object that is worn by the target person 400 and that can identify the target person 400 as an individual, the accuracy of identifying the target person 400 as an individual can be improved by improving the sensitivity of detecting a color of the specific object.

The corrector 114 corrects the joint points 410 by complementing the joint points 410 detected by the position detector 111 in the region estimated by the estimator 113.

The color information acquirer 115 acquires, from the captured image, the color information of the region that is to be estimated and is included in the joint points 410 after the correction by the corrector 114 as color information belonging to the target person 400 (object). The color information is, for example, an average of pixel values included in the region to be estimated in the captured image.

The region whose color information is acquired by the color information acquirer 115 is not limited to the region to be estimated. The color information acquirer 115 may acquire, from the captured image, color information of any joint point 410 or color information of a region including any joint point 410. The joint point 410 or the region including the joint point 410 from which the color information is acquired can be set in advance by being stored in the storage 120 or the like.

The behavior estimator 116 estimates a behavior of the target person 400 based on the joint points 410 corrected by the corrector 114. The behavior estimator 116 can estimate the behavior of the target person 400 based on, for example, a difference in posture due to the joint points 410 estimated for each of frames of a plurality of captured images that are consecutive in time series. The difference may be an average or a sum of differences between the corresponding joint points 410 estimated for the frames of the plurality of captured images that are consecutive in time series for each of the corresponding joint points 410. For example, a behavior of falling can be estimated from the fact that after the difference in posture due to the joint points 410 exceeds a predetermined threshold, the difference in posture almost disappears. The behavior estimator 116 can estimate the behavior of the target person 400 based on the corrected joint points 410 by using any known behavior estimation method.

The individual determinator 117 determines the target person 400 as an individual based on the color information acquired by the color information acquirer 115. Determining the target person 400 as an individual based on the color information corresponds to determining identification information identifying the target person 400 (object) based on the color information. The identification information includes, for example, information that can identify the individual, such as a name. Specifically, for example, the individual determinator 117 determines the target person 400 as an individual by identifying the name of the target person 400 based on the acquired color information by referring to a table in which the color information and the name of the target person corresponding to the identification information are associated with each other.

By acquiring, as the color information, the color information of the head region 410s that is the region to be estimated, it is possible to determine the target person 400 as an individual based on the color information, for example, in a case where the target person 400 wears a hat or the like in a color that can identify the individual.

In a case where a color of work clothes worn by the target person 400 on the upper body of the target person 400 can identify the individual, or the like, the region from which the color information is acquired by the color information acquirer 115 is set to a region including a joint point 410 of an “elbow”, and thus the target person 400 as an individual can be determined based on the color information. In addition, in a case where a color of work clothes worn by the target person 400 on the lower body of the target person 400 can identify the individual, or the like, the region from which the color information is acquired by the color information acquirer 115 is set to a region including a joint point 410 of a “knee”, and thus the target person 400 as an individual can be determined based on the color information.

The behavior estimator 116 and the individual determinator 117 can output, for each target person 400, the result of estimating the behavior and a result of determining the target person 400 as an individual in association with each other. Thus, it is possible to grasp a behavior of each target person 400 as an individual.

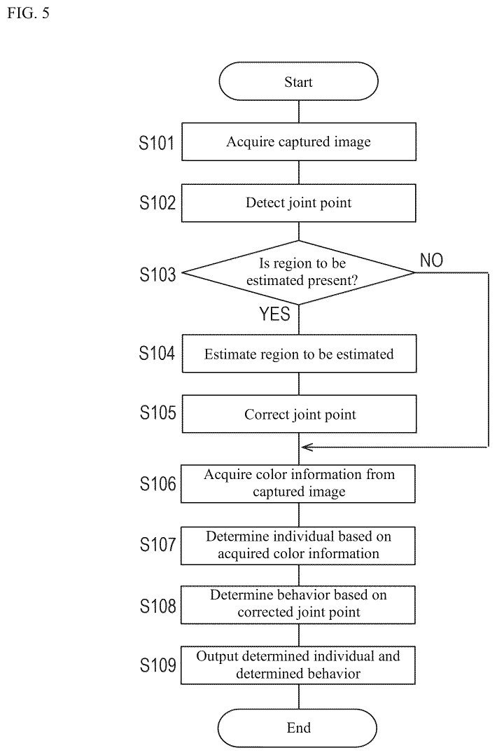

FIG. 5 is a flowchart illustrating an operation of the analysis apparatus 100. This flowchart can be performed by the controller 110 of the analysis apparatus 100 in accordance with a program. Steps S102 to S107 can be performed for each frame of the captured image.

The controller 110 acquires the captured image by receiving the captured image from the image capturing apparatus 200 (S101).

The controller 110 detects a joint point 410 of the target person 400 from the captured image (S102).

The controller 110 determines whether or not the region to be estimated is present, based on the detected joint point 410 (S103). The controller 110 compares, for example, the class of the detected joint point 410 with the classes of the necessary joint points and determines that the region to be estimated is present in a case where a class among the classes of the necessary joint points is not included in the class of the detected joint point 410.

In a case where the controller 110 determines that the region to be estimated is not present (S103: NO), the controller 110 performs step S106.

In a case where the controller 110 determines that the region to be estimated is present (S103: YES), the controller 110 estimates the region to be estimated (S104).

The controller 110 corrects the detected joint point 410 by complementing the detected joint point 410 in the estimated region (S105).

The controller 110 acquires the color information from the captured image (S106). In a case where the region to be estimated is present, the controller 110 can acquire, from the captured image, the color information of the region to be estimated. In a case where the region to be estimated is not present, the controller 110 can acquire, from the captured image, color information of a preset joint point 410 from which the color information is acquired, or color information of a region including the joint point 410.

The controller 110 determines the target person 400 as an individual based on the acquired color information (S107).

The controller 110 determines a behavior of the target person 400 based on the corrected joint point 410 in step S105 (S108).

The controller 110 outputs the determined individual and the determined behavior in association with each other (S109). The output may include transmission to an external device, origination without identifying a transmission destination, and display on the operation display part 140 or the like.

### Second Embodiment

A second embodiment will be described. The present embodiment is different from the first embodiment in the following points. In the first embodiment, the color information of the region to be estimated is acquired from the captured image. On the other hand, in the present embodiment, color information of a color acquisition region received from a user is acquired from a captured image. In other respects, the present embodiment is similar to the first embodiment, and therefore, redundant description is omitted.

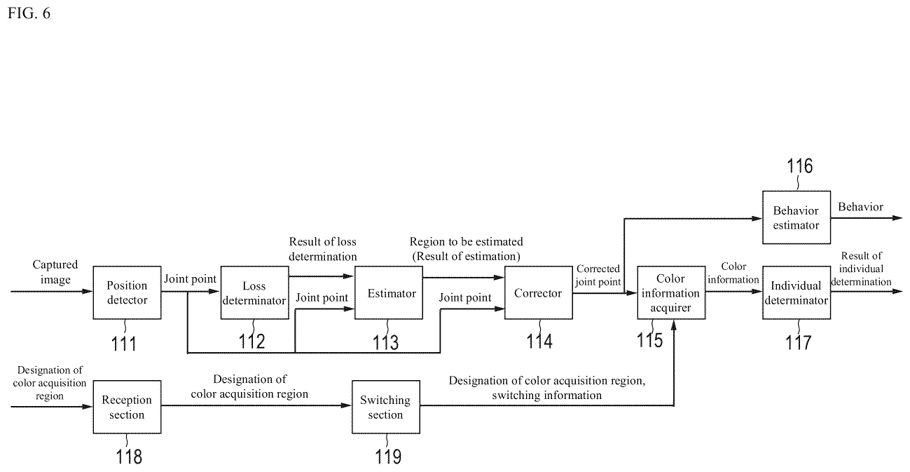

FIG. 6 is a block diagram illustrating functions of a controller 110 of an analysis apparatus 100. The controller 110 functions as a position detector 111, a loss determinator 112, an estimator 113, a corrector 114, a color information acquirer 115, a behavior estimator 116, an individual determinator 117, a reception section 118, and a switching section 119 by executing a program.

The reception section 118 receives designation of a color acquisition region input to the operation display part 104 by the user. The color acquisition region is a region whose color information is acquired by the color information acquirer 115. The designation of the color acquisition region can be designation based on a joint point 410 (e.g., the joint point 410c of the “right shoulder”) or a region including the joint point 410. In a case where the designation of the color acquisition region is the designation based on the joint point 410, the color acquisition region may be at coordinates corresponding to the joint point 410 or may be a region of a predetermined size including the coordinates corresponding to the joint point 410.

The color information acquirer 115 identifies the color acquisition region based on the designation of the color acquisition region and acquires the color information of the identified color acquisition region from the captured image.

The switching section 119 generates switching information for switching the size of the color acquisition region based on the designated color acquisition region and switches the size of the color acquisition region in which the color information acquirer 115 acquires the color information from the captured image. Specifically, the switching section 119 switches the size of the color acquisition region based on the designated color acquisition region, for example, with reference to a table in which the color acquisition region and the size of the color acquisition region are associated with each other. The relationship between the color acquisition region and the size of the color acquisition region can be appropriately set according to the size or range of personally identifiable colored work clothes, a name tag, or the like to be worn by the target person 400.

In the present embodiment, since the color acquisition region can be set to any region by designating the color acquisition region, it is possible to acquire color information of a joint point 410 which is most suitable for identifying an individual based on the color information, or color information in a region including the joint point 410. For example, in a case where the target person 400 wears a hat or the like in a color that can identify the individual, color information of the hat or the like can be acquired as the color information by designating the joint point 410 of the “head” as the color acquisition region. In a case where a color of work clothes that the target person 400 wears on the upper body of the target person 400 is a color that can identify the individual, color information of a hat or the like can be acquired as the color information by designating the joint point 410 of the “elbow” as the color acquisition region. In addition, in a case where a color of work clothes that the target person 400 wears on the lower body of the target person 400 is a color with which the individual can be identified, color information of a hat or the like can be acquired as the color information by designating the joint point 410 of the “knee” as the color acquisition region.

The embodiments produce the following effects.

A position of a joint of an object is detected from an image of the object, and a region to be estimated is estimated based on the position of the joint. Accordingly, even in a case where a joint or a region desired to be estimated is not estimated for some reason, it is possible to complement the joint or the region while eliminating a need for a worker to wear a terminal and a need to perform new learning.

Furthermore, based on the joint point detected in a frame of the image, the region to be estimated in the frame in which the joint point has been detected is estimated. Thus, the region to be estimated can be estimated more easily.

Further, whether or not the region to be estimated is present is determined based on the detected joint point, and in a case where it is determined that the region to be estimated is not present, the region to be estimated is estimated. The joint point is corrected by complementing the detected joint point in the estimated region. Then, color information belonging to the object is acquired from the image based on the estimated region. Thus, the accuracy of estimating a behavior of the object can be improved, and the color information belonging to the object can be easily acquired with high accuracy.

Further, the joint point is corrected by complementing the detected joint point in the estimated region, designation of a color information acquisition region is received, and color information belonging to the object is acquired from the image based on the designation of the color information acquisition region. Thus, the accuracy of estimating a behavior of the object can be improved, and color information belonging to the object can be acquired flexibly and simply.

Furthermore, the size of the region to be estimated is switched according to the region to be estimated. Thus, the sensitivity of identifying an object based on color information can be improved.

Furthermore, a region to be estimated is a joint point or a region including the joint point. Thus, the region to be estimated can be easily and appropriately estimated.

Further, an image acquirer that acquires an image is provided. Thus, the joint point can be detected with high accuracy using an appropriate image.

Furthermore, the object includes a person. Thus, the accuracy of detecting the joint point can be improved.

Furthermore, the object included in the image is an object having a joint. Thus, the accuracy of detection can be improved while a target for detection of a joint point is expanded.

Furthermore, the region to be estimated is a region including the joint point of a head. Thus, the region to be estimated can be estimated more easily and accurately.

Further, the estimated region is complemented to the joint point to correct the joint point, and a behavior of the object may be estimated based on the corrected joint point. Identification information identifying the object is determined based on the acquired color information. Then, the estimated behavior and the determined identification information are output in association with each other for each object. Thus, the behavior of the individual can be visualized more easily and accurately.

The present invention is not limited to the above-described embodiments.

For example, a step among the steps of the flowchart of FIG. 5 may be omitted.

Furthermore, any two or more of the steps may be performed in parallel in order to, for example, reduce the processing time.

Furthermore, a part or a whole of the processes performed by the programs in the embodiments may be performed in the form of hardware such as circuits.

This present application is based on Japanese Patent Application (Japanese Patent Application No. 2021-196700) filed on Dec. 3, 2021, the disclosure of which is incorporated by reference in its entirety.

### REFERENCE SIGNS LIST

10 analysis system
100 analysis apparatus
110 controller
111 position detector
112 loss determinator
113 estimator
114 corrector
115 color information acquirer
116 behavior estimator
117 individual determinator
118 reception section
119 switching section
120 storage
130 communicator
140 operation display part
200 image capturing apparatus
300 communication network

1. A region estimation system comprising:
a hardware processor that:
detects a joint point of an object from an image of the object; and
estimates a region to be estimated, based on the joint point detected by the detector.

2. The region estimation system according to claim 1, wherein
the hardware processor estimates, based on the joint point detected in a frame of the image, the region to be estimated in the frame in which the joint point has been detected.

3. The region estimation system according to claim 1, wherein
the hardware processor
determines whether or not the region to be estimated is present, based on the detected joint point,
estimates the region to be estimated in a case where the hardware processor determines that the region to be estimated is not present,
corrects the detected joint point in the estimated region to be estimated; and
acquires color information belonging to the object from the image based on the estimated region to be estimated.

4. The region estimation system according to claim 1, wherein:
the hardware processor corrects the detected joint point in the estimated region to be estimated;
receives designation of a color information acquisition region; and
acquires color information belonging to the object from the image based on the received designation of the color information acquisition region.

5. The region estimation system according to claim 4, wherein
the hardware processor switches a size of the region to be estimated according to the region to be estimated.

6. The region estimation system according to claim 1, wherein the region to be estimated is the joint point or a region including the joint point.

7. The region estimation system according to claim 1, wherein
the hardware processor further acquires the image.

8. The region estimation system according to claim 1, wherein the object includes a person.

9. The region estimation system according to claim 1, wherein the object has a joint.

10. The region estimation system according to claim 1, wherein the region to be estimated is a region including the joint point of a head.

11. The region estimation system according to claim 3, wherein
the hardware processor estimates a behavior of the object based on the corrected joint point;
determines identification information individually identifying the object based on the acquired color information; and
outputs, for each object, the estimated behavior and the determined identification information in association with each other.

12. A non-transitory computer-readable storage medium storing a region estimation program for causing a computer to execute a process, the process comprising:
(a) detecting a joint point of an object from an image of the object; and
(b) estimating a region to be estimated, based on the joint point detected in (a).

13. The non-transitory computer-readable storage medium storing the region estimation program according to claim 12, wherein in (b), the region to be estimated in a frame in which the joint point has been detected is estimated based on the joint point detected in the frame of the image.

14. The non-transitory computer-readable storage medium storing the region estimation program according to claim 12, the process further comprising:
(c) determining whether or not the region to be estimated is present, based on the detected joint point, wherein
the region to be estimated is estimated in a case where it is determined that the region to be estimated is not present in (b), the process further comprising:
(d) correcting the detected joint point in the estimated region to be estimated; and
(e) acquiring color information belonging to the object from the image based on the estimated region to be estimated.

15. A region estimation method comprising:
(a) detecting a joint point of an object from an image of the object; and
(b) estimating a region to be estimated, based on the joint point detected in (a).

16. The region estimation method according to claim 15, wherein in (b), the region to be estimated in a frame in which the joint point has been detected is estimated based on the joint point detected in the frame of the image.

17. The region estimation method according to claim 15, further comprising:
(c) determining whether or not the region to be estimated is present, based on the detected joint point, wherein
the region to be estimated is estimated in a case where it is determined that the region to be estimated is not present in (b), the region estimation method further comprising:
(d) correcting the detected joint point in the estimated region to be estimated; and
(e) acquiring color information belonging to the object from the image based on the estimated region to be estimated.
